(19) United States
(12) Patent Application Publication
(10) Pub. No.: US 2017/0101128 A1
(43) Pub. Date: Apr. 13, 2017

(54) POWER STEERING ASSEMBLY WITH DIFFERENTIAL ANGLE SENSOR SYSTEM

(71) Applicant: TEDRIVE STEERING SYSTEMS GMBH, Wulfrath (DE)

(72) Inventors: Sven KIRSCHBAUM, Mettmann (DE); Jens-Hauke MULLER, Velbert-Neviges (DE)

(21) Appl. No.: 15/387,267

(22) Filed: Dec. 21, 2016

Related U.S. Application Data
(63) Continuation-in-part of application No. 14/361,607, filed on May 29, 2014, now abandoned.

(30) Foreign Application Priority Data
Jan. 10, 2012 (DE) 10 2012 100 133.2
Aug. 7, 2012 (DE) 10 2012 107 211.6

(51) Int. Cl. B62D 6/10; B62D 5/06; B62D 5/22; B62D 5/09

(52) U.S. Cl. CPC B62D 6/10; B62D 5/09; B62D 5/062; B62D 5/22; B60Y 2304/01; B60Y 2304/03; B60Y 2304/05

(57) ABSTRACT

A power steering assembly for a hydraulic power steering system of motor vehicles includes an input shaft configured for connection to a steering wheel, an output shaft coupled to the input shaft configured for operational engagement with a steering rod, a hydraulic servo valve, an actuator, a sensor system, and an evaluation unit. The coupling between the input and output shafts is realized by a torsion bar and permits a first relative rotation between the input and output shafts. The hydraulic servo valve, which controls a hydraulic pressure and thus a steering assistance depending on the steering torque applied by a driver, has a rotatable control element engaged with, and driven by, the output shaft. An engagement between the output shaft and control element provides for a second relative rotation therebetween. This engagement includes a multi-stage planetary gear unit. The steering power assistance system is controlled depending on a third relative roation between the input shaft and control element. The actuator relatively displaces the control element in relation to the output shaft to influence the steering power assistance characteristics. The sensor system measures at least one differential angle between the control element and input shaft, wherein the control element is a valve sleeve disposed coaxially with the input and output shafts and the sensor system includes an encoder sleeve non-rotatably connected to the valve sleeve.

### CROSS-REFERENCE TO RELATED APPLICATIONS

This application is a continuation-in-part of and claims priority under 35 U.S.C. §120 to U.S. patent application Ser. No. 14/361,607, filed on May 29, 2014, which in turn is a National Stage Entry entitled to and hereby claims priroity under 35 U.S.C. §§365 and 371 to corresponding PCT Application No. PCT/EP2013/050162, filed on Jan. 7, 2013, which in turn claims priority to German Patent Application Serial No. DE 10 2012 100 133.2, filed on Jan. 10, 2012 and German Patent Application Serial No. DE 10 2012 107 211.6, filed on Aug. 7, 2012. All of said applications are herein incorporated by reference in their entirety.

### FIELD

The present disclosure relates to a power steering assembly for a power steering system, in particular for a hydraulic power steering system, of motor vehicles and to a corresponding use.

### BACKGROUND

Among other things, power steering assemblies for hydraulic power steering systems of vehicles comprise servo valves also known as rotary servo valves. They control the hydraulic pressure and thus the steering assistance depending on the steering torque applied by the driver. Most frequently, rotary servo valves are used in which an input shaft connected via a steering column with a steering wheel rotates relative to a valve portion (also referred to as control element, control sleeve or sleeve), which is connected to the output shaft and, in rack-and-pinion steering systems, with a steering pinion (also referred to as pinion). A torque-dependent adjustment of the control element of the servo valve, and thus torque-dependent valve characteristics and therefore steering power assistance characteristics, are realized through a torsion system between the input shaft and the control element.

In order to realize various further functions of a torque adjuster, for example a lane departure assistant, over- or understeering assistant, tactile feedback, variable steering assistance, for instance dependent on the vehicle speed or load, city mode, parking pilot, steering torque superposition, an adjustment of the position of the control element independent from the applied torque for the purpose of influencing the steering power assistance characteristics of the servo valve is known.

Such a servo steering valve is described, for example, in the published patent application DE 10 2004 049 686 A1. Here, the adjustment of the steering power assistance characteristics is achieved by adjusting the relative angle between the control element and an output shaft of the servo valve.

### SUMMARY

A need exists for further developing the power steering assembly of the type mentioned at the beginning such that its function can be better monitored in order to enhance driving safety and/or improve control of the steering power assistance system.

The power steering assembly according to the disclosure for a power steering system of motor vehicles comprises an input shaft for connection to a steering wheel, an output shaft which is coupled to the input shaft for operational engagement with a steering rod, the coupling between the input shaft and the output shaft permitting a relative rotation between them. According to the disclosure, a servo controller, preferably a hydraulic servo valve, is also provided which has a rotatable control element that is in engagement with and driven by the output shaft, the steering power assistance system being controlled depending on the relative rotation between the input shaft and the control element. According to the disclosure, the engagement between the output shaft and the control element provides for a relative displacement between the output shaft and the control element. Further, an actuator, for example an electromotive or electromagnetic actuator, is provided according to the disclosure for relatively displacing the control element in relation to the output shaft in order to influence the steering power assistance characteristics.

The power steering assembly according to the disclosure further comprises a sensor system for measuring at least one differential angle between the control element and the output shaft or between the control element and the input shaft.

Moreover, an evaluation unit is provided for evaluating the measurement values provided by the sensor system. Advantageously, the provided data serve for monitoring the function and safety of the servo assembly.

The purpose of the disclosure is to obtain, in a steering system with a control element that is rotatable relative to the output shaft in order to influence the steering assistance system, important information from a fail-safe and control engineering standpoint. The insertion of a second elasticity (T-bar) between the input shaft and the output shaft for the relative rotation in the steering line, which would be required for a conventional torque sensor, can be omitted, accompanied by the advantage that the steering feel would otherwise be adversely affected.

Owing to the position of the sensor system on the steering gear close to the steering gear, the angle of rotation can be measured directly between the input shaft and the control element. In the generic servo assembly, the rotation can be caused either by the driver and/or by the actuator. In the case that the actuator and the driver simultaneously act on the control element and cause a displacement, this information can be reconstructed by calculation and the pure driver information can be determined by knowing the displacement distance of the actuator. For fail-safe reasons, this is important information in order to determine whether the driver is in contact with the steering wheel.

Moreover, the vehicle manufacturer can dispense with the integration of a steering angle sensor close to the steering wheel into the steering column. This saves construction space, costs and weight of the vehicle.

The full functional capability of the actuator-operated relative displacement of the control element in relation to the output shaft can be tested in the form of a system self test prior to the start of the journey. As long as the driver has not yet started the engine and steering assistance by the pump is not yet provided, the actuator can test the full functional capability of the system by rotating the control element over its entire displacement distance, for example up to the respective stop.

It is possible, for example, to derive therefrom the neutral position relative to the change of the steering power characteristics that can be caused by the displacement mechanism, for example the middle position thereof, and to check whether the system has become misaligned since the last journey or journeys, for example by data stored in the EEPROM with the currently determined ones.

As long as the actuator is in the neutral position during driving, conclusions can be drawn from the differential angle as to the steering torque set by the driver. Furthermore, it is possible to determine an offset of the system in the long run. As a rule, the signal of the sensor system should be compared to other signals available in the vehicle. For example, it is possible to determine different driving situations (e.g. straight driving) by comparing the wheel speeds, measuring the transverse acceleration or determining the yaw rate. In that case, the balancing of the control element to the neutral position could be readjusted, so that a torque-neutral steering is possible for the driver in the case of straight driving, depending on the situation.

Moreover, it would be possible to determine, by means of minute control steps of the actuator, the mechanical displacement hysteresis/play. Since the sensor system has a very small resolution, these control steps cannot be resolved by the driver, but the mechanical hysteresis information can be implemented into the control strategy, for example through manufacturing tolerances. In a next step, the increase of the play can then be determined from the above function via the lifetime of the system, for example through the wear, and can also be compensated.

With that knowledge, it is possible during a steering process to determine, by the driver and the simultaneous setting of the control element by the actuator, whether the desired additional displacement was actually set. It is also possible to additionally derive therefrom whether the driver is still in contact with the steering wheel at all. If that is not the case, then the control element, for example the valve sleeve, must be rotated into the neutral position via the actuator, because an inadvertent steering process would otherwise be initiated through the actuator, and the vehicle would leave the desired trajectory.

As long as the driver steers with simultaneous superposition, the steering torque set by the driver can inversely also be determined therefrom by difference calculation, of course.

In principle, the assembly according to the disclosure can be combined with any steering gear between the output shaft and the steering rod or steering shaft, with a rack-and-pinion gear or a recirculating ball steering gear being preferred. The terms steering rod and steering shaft are to be interpreted as synonyms and depend on the type of steering gear used in each case. A recirculating ball steering gear—the steering system is in that case also referred to as block steering system—is used with preference in the utility vehicle area, particularly in combination with a hydraulic servo valve.

According to another advantageous embodiment, the actuator is a stepping motor. Thus, an encoder on the motor, for example, for measuring the set relative displacement can be dispensed with. Based on the requested steps and the translation of the control gear, a prognosis can be made with a stepping motor on the expected relative displacement for the control element, for example the valve sleeve. Furthermore, by comparing the information from the stepping motor and the sensor system, it is possible to check whether the desired request was made or whether there is a control error in the form of too little, too much, or inadvertent.

Preferably, the engagement between the output shaft and the control element comprises a multi-stage planetary gear unit.

Preferably, the servo valve and the sensor system are accommodated in a valve tower of the steering-gear housing, or the sensor system can at least be attached to the valve tower of the steering-gear housing.

Preferably, the control element is a valve sleeve disposed coaxially with the input and the output shaft.

The sensor system preferably comprises a differential angle sensor or at least two angle sensors. These are preferably non-contact sensors, such as optical, inductive or magnetic sensors. More preferably, these are sensors with permanent-magnetic encoders or inductive sensors.

According to a preferred embodiment, the sensor system comprises an encoder sleeve non-rotatably connected to the valve sleeve.

### BRIEF DESCRIPTION OF FIGURES

FIG. 1: shows a sectional view along the longitudinal axis of a first embodiment of the power steering assembly according to the disclosure;

FIG. 2: shows a cross-sectional view of a second embodiment;

FIG. 3: shows a cross-sectional view of a third embodiment;

FIG. 3A: shows a cross-sectional view of the third embodiment; and

FIG. 4: shows a cross-sectional view of the third embodiment.

### DETAILED DESCRIPTION OF THE FIGURES

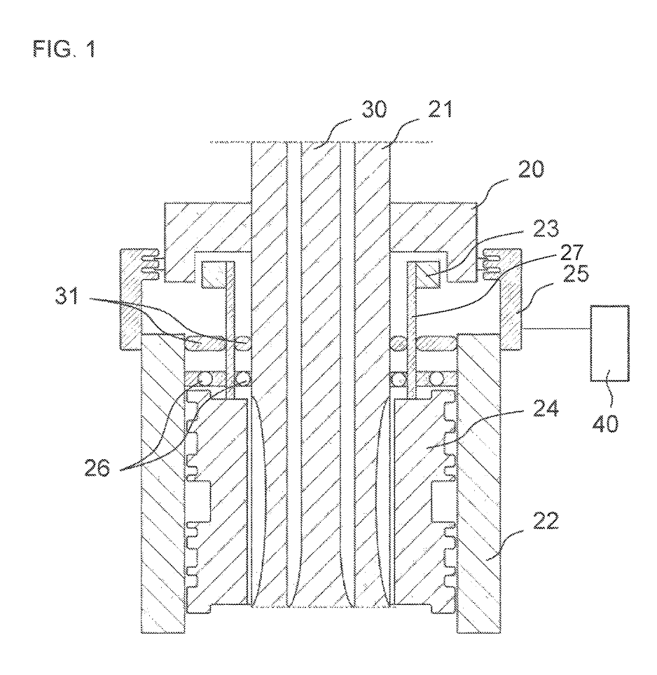

In the embodiment shown in FIG. 1, a differential angle sensor substantially comprising parts 20, 23, 25, and 27 is pushed over the input shaft 21 and attached to the housing above the valve tower 22. The main component 20 of the differential angle sensor is non-rotatably connected to the input shaft 21, and the magnet 23, by means of an encoder sleeve 27 that is non-rotatably connected to the valve sleeve 24 as a control element, leads the angle of rotation of the sleeve 24 out from the hydraulic region of the valve tower. The third part 25 of the sensor is stationarily connected to the valve tower 22 and provides the differential angle information concerning the differential angle between the input shaft 21 and the valve sleeve 24 to the evaluation unit 40 via a connector or the like.

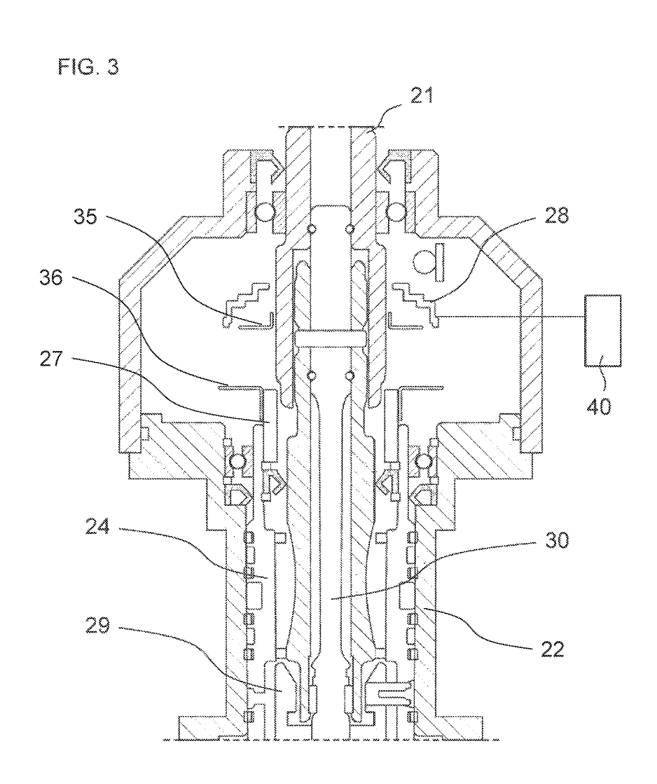

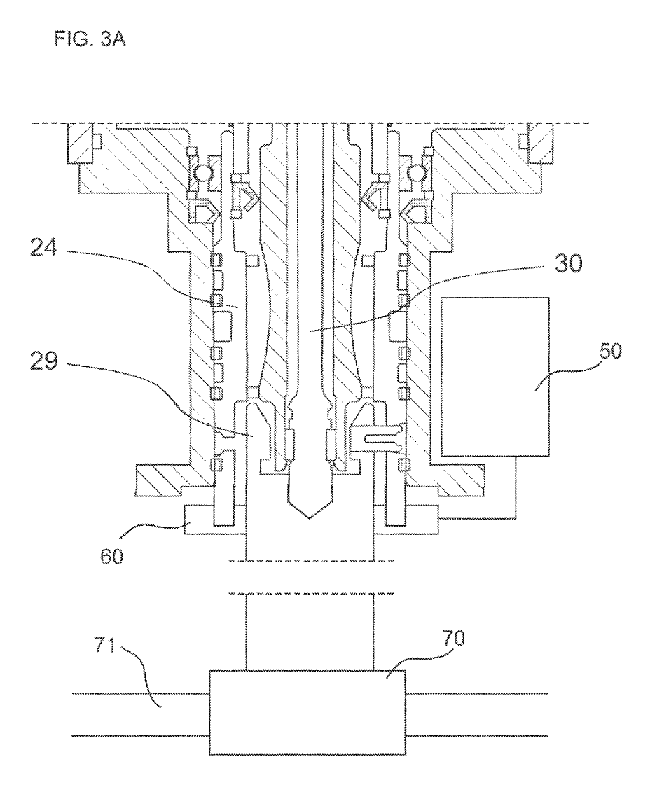

An output shaft 29 (shown in FIGS. 3 and 3A) is coupled to the input shaft 21, wherein the coupling between the input shaft 21 and the output shaft 29 is realized by a torsion bar 30.

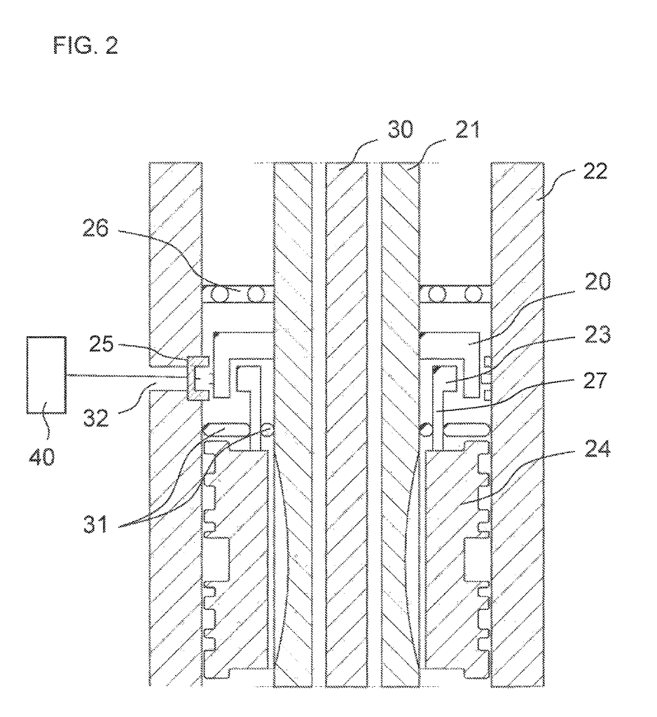

In the embodiment according to FIG. 1, the bearing (which is normally provided, as a rule, in hydraulic steering systems) comprises two concentrically disposed ball bearings 26 in order to center the input shaft 21 in the valve tower 22 and to compensate axial forces. The embodiment according to FIG. 2 shows a variation thereof. The valve tower 22 is made longer and the above-mentioned centering bearing 26 is installed above the sensor parts 20, 23, 25, and 27. The third part 25 of the differential angle sensor is stationarily connected to the valve tower 22 and provides the differential angle information concerning the differential angle between the input shaft 21 and the valve sleeve 24 to the evaluation unit 40 via a connector or the like. As shown in the embodiment according to FIG. 2, the sensor parts 20, 23, and 25 are accommodated within the valve tower 22 so that an opening 32 is provided in the valve tower 22 for electrical connection of the third part 25 to the evaluation unit 40.

FIG. 3 shows another embodiment, which, among other things, is different due to the use of an inductive sensor substantially comprising parts 27, 28, 35, and 36 for determining the differential angle between the input shaft 21 and the valve sleeve 24. To this end, the housing 28 of the inductive sensor is connected to the valve tower 22 and the differential angle is measured between a first rotor 35 non-rotatably connected to the input shaft 21 and a second rotor 36 non-rotatably connected to the encoder sleeve 27. The housing 28 of the inductive sensor is connected to the evaluation unit 40 in order to provide the differential angle information thereto.

FIG. 3A basically shows the embodiment of FIG. 3, but includes an actuator 50 for relatively displacing the control element 24 in relation to the output shaft 29. Furthermore, a multi-stage planetary gear unit 60 between the output shaft 29 and the control element 24 is schematically shown. In addition, a rack-pinion gear/recirculation ball steering gear 70 is schematically shown between the output shaft 29 and the steering rod 71.

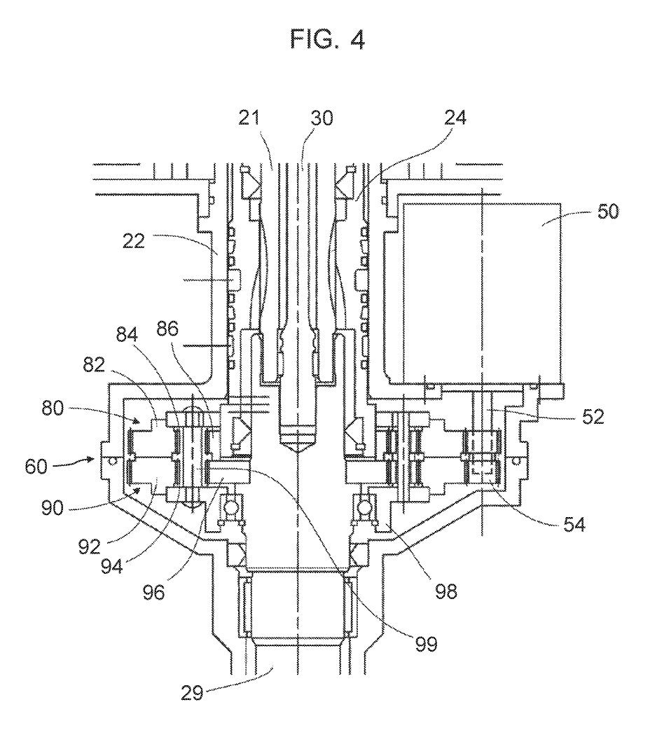

FIG. 4 shows a more detailed cross-sectional view of the third embodiment shown in FIG. 3A. Particularly, FIG. 4 shows an exemplary embodiment of the multi-stage planetary gear unit 60 and the actuator 50.

In the embodiment shown, the planetary gear unit 60 comprises two planetary gear trains 80 and 90.

The input shaft 21 is connected to the output shaft 29 via the torsion bar 30, which is largely surrounded by the input shaft 21, the torsion bar 30 on its one end being non-rotatably connected to the input shaft 21 and on its other end non-rotatably connected to the output shaft 29. Moreover, the control element 24 is disposed concentrically with and around the input shaft 21. The control element 24 is mounted so as to be rotatable and/or displaceable relative to the input shaft 21.

The power steering assembly is encompassed by a housing 22. The first planetary gear train 80 and the second planetary gear train 90 are disposed in the housing 22. Each planetary gear train 80, 90 substantially comprises a sun gear 86, 96, several planet gears 84, 94 and a ring gear 82, 92. The first planetary geartrain 80 is associated with the control element 24 and the second planetary gear train 90 is associated with the output shaft 29, with the sun gears 86, 94 respectively being non-rotatably connected to the control element 24 or the output shaft 29. The ring gears 82, 92 of the two planetary gear trains 80, 90 are monnted so as to be rotatable independently from each other. Coupling of the two planetary gear trains 80, 90 is accomplished by means of a common planet carrier 98 which carries the planet gears 84, 94 of the two gear trains 80, 90, respectively, on common shafts 99. In this case, the planet gears 84, 94 are mounted so as to be rotatable independently from each other on the shafts 99.

The ring gears 82, 92 of the two planetary gear trains 80, 90 each comprise an external toothing as well as an internal toothing. In particular, the ring gears 82, 92 have different external toothings, with the number of teeth of the ring gear 92 generally being smaller than the number of teeth of the ring gear 82.

A two-stage pinion 54 is in rotational engagement with the external toothing of the two ring gears 82, 92. The two-stage pinion 54 also has two different toothings. The pinion 54 is non-rotatably connected to a drive shaft 52 of the actuator 50.

As can be seen in FIG. 4, the actuator 50 is disposed outside the housing 22. In the exemplary embodiment described here, the actuator 50 is an electric motor. In particular, the actuator 50 is a stepper motor. The actuator 50 drives the two-stage pinion 54 directly via the drive shaft 52. At the location where the actuator 50 is attached to the housing 22, the housing 22 has an opening through which the drive shaft 52 including the pinion 54 can be guided for assembly purposes. The seal between the actuator 50 and the planetary gear trains 80, 90 is realized by a shaft-sealing ring, O-ring or the like, which is not shown in FIG. 4. The common planet carrier 98 of the two planetary gear trains 80, 90 is rotatably mounted by means of corresponding bearings on the output shaft 29.

When the actuator 50 rotates the two-stage pinion 54, the two ring gears 82, 92 of the planetary gear trains 80, 90 are also made to rotate due to the rotational engagement with the pinion 54. Because the two ring gears 82, 92 have different external toothings, the result of the rotation is a difference angle between the ring gears 82, 92. This difference angle is transferred slightly amplified to a relative adjustment, particularly to a relative angle, between the control element 24 and the output shaft 29 by the transmission of the planetary gear trains 80, 90. If no relative adjustment is to be set between the control element 24 and the output shaft 29, the two ring gears 82, 92 are held in position through the two stage pinion 54.

If the input shaft 21 is rotated, the torque is transmitted through the torsion bar 30 onto the output shaft 29. Due to the torque transmission of the torsion bar 30, the latter is rotated, and thus the input shaft 21 relative to the output shaft 29. A steering movement or rotation of the output shaft 29 now leads to a rotation of the sun gear 96, which is non-rotatably connected to the output shaft 29. Since the ring gear 92 associated with the same planetary gear train 90 is retained on its external toothing by the pinion 54, the planetary gears 94 have to roll between the sun gear 96 and the ring gear 92. This process causes the common planet carrier 98 to rotate. Due to the rotation of the planet carrier 98 and the retention of the ring gears 82, 92 of the two planetary gear trains 80, 90 the planet gears 84 of the planetary gear train 80 associated with the control element 24 have to roll off the planetary gear train's ring gear 82. Thus, the rotation of these planet gears 84 causes a rotation of the sun gear 86, which is non-rotatably connected to the control element 24. Due to the identical transmissions of the two planetary gear trains 80, 90 the sun gear 86 associated with the control element 24 is rotated by the same angle as the sun gear 96 associated with the output shaft 29. Therefore, the control element 24 follows the rotation of the output shaft 29.

If a difference angle is now to be set, the two-stage pinion 54 is rotated by the actuator 50. This causes a difference angle between the two ring gears 82, 92 of the planetary gear trains 80, 90. This difference angle is transferred, amplified by the transmission of the planetary gear trains, to a relative adjustment, particularly to a relative angle, between the control element 24 and the output shaft 29.

1. A power steering assembly for a hydraulic power steering system of motor vehicles, comprising:
an input shaft configured for connection to a steering wheel;
an output shaft coupled to the input shaft configured for operational engagement with a steering rod, wherein the coupling between the input shaft and the output shaft is realized by a torsion bar and permitting a first relative rotation between the input shaft and the output shaft;
a hydraulic servo valve which controls a hydraulic pressure and thus a steering assistance depending on the steering torque applied by a driver, wherein the hydraulic servo valve has a rotatable control element engaged with the output shaft and driven by the output shaft, wherein an engagement between the output shaft and the control element provides for a second relative rotation between the output shaft and the control element, wherein said engagement between the output shaft and the control element comprises a multi-stage planetary gear unit, and the steering power assistance system is controlled depending on a third relative roation between the input shaft and the control element;
an actuator configured for relatively displacing the control element in relation to the output shaft to influence the steering power assistance characteristics;
a sensor system configured for measuring at least one differential angle between the control element and the input shaft, wherein the control element is a valve sleeve disposed coaxially with the input and the output shaft and the sensor system includes an encoder sleeve non-rotatably connected to the valve sleeve;
an evaluation unit for evaluating the measurement values provided by the sensor system.

2. The power steering assembly according to claim 1, further including a steering rod, with a rack-and-pinion gear or a recirculating ball steering gear being provided between the output shaft and the steering rod.

3. The power steering assembly according to claim 1, wherein the actuator is a stepping motor.

4. The power steering assembly according to claim 1, further including a steering-gear housing with a valve tower, wherein the servo valve and the sensor system are accommodated in the valve tower and/or the servor valve and the sensor system are attached to the valve tower.

5. The power steering assembly according to claim 1, wherein the sensor system includes a differential angle sensor or at least two angle sensors.

6. A motor vehicle having a power steering assembly according to claim 1.
